(19) United States
(12) Patent Application Publication
(10) Pub. No.: US 2005/0183734 A1
(43) Pub. Date: Aug. 25, 2005

(54) Method and apparatus for removing foreign matter from tobacco to be processed

(75) Inventors: Harry Drewes, Hamburg (DE); Frank Schuster, Hamburg (DE)

Correspondence Address: VENABLE LLP, P.O. BOX 34385, WASHINGTON, DC, 20045-9998, US

(73) Assignee: HAUNI PRIMARY GMBH, Hamburg (DE)

(21) Appl. No.: 11/060,489

(22) Filed: Feb. 18, 2005

(30) Foreign Application Priority Data
Feb. 19, 2004 (DE) 10 2004 008 642.7

(51) Int. Cl. A24B 5/08; A24B 5/16; B07C 5/00

(52) U.S. Cl. 131/325; 209/577

(57) ABSTRACT

The invention concerns an apparatus and a method for removing foreign matter from tobacco to be processed. With known apparatuses, a stream of material substantially consisting of tobacco is guided over and through several components connected one behind the other, namely, delivery device, apparatus for removing foreign matter, vibrating element, conveying element for accelerating the stream of material, and an optical testing element. This takes up a large amount of space. Furthermore, the manufacturing costs for such apparatuses and the corresponding methods are high. The object of providing a compact and more cost-efficient apparatus is achieved by the fact that the apparatus for removing the foreign matter is arranged directly above the conveying element which accelerates the stream of material. Several components can be saved as a result, so that the space requirements as well as the manufacturing costs fall. The same applies to the corresponding method.

### CROSS-REFERENCE TO RELATED APPLICATION

This application claims the priority of German Patent Application No. 10 2004 008 642.7 filed Feb. 19, 2004, the subject matter of which is incorporated herein by reference.

### BACKGROUND OF THE INVENTION

The invention is concerned with an apparatus for removing foreign matter from tobacco to be processed, in the direction of transport T of the tobacco, including a delivery device for delivering a stream of material essentially consisting of tobacco, an apparatus for removing foreign matter from the stream of material, at least one conveying element which accelerates the stream of material, and an optical testing element for detecting further foreign matter with a device for separating the foreign matter from the tobacco. Furthermore the invention concerns a method for removing foreign matter from tobacco to be processed, including the steps of: delivering a stream of material essentially consisting of tobacco to an apparatus for removing foreign matter from tobacco to be processed, removing foreign matter from the stream of material by means of the corresponding apparatus, passing the stream of material onto a conveying element which accelerates the stream of material, detecting further foreign matter by means of an optical testing element, and separating the foreign matter from the tobacco.

Such apparatuses and methods are used in the tobacco-processing industry in tobacco preparation, also called primary. To prepare the tobacco which is usually packed as bales or the like in sacks, crates or the like for subsequent cigarette manufacture, apparatuses with the features of the introductory part of claim 1 and methods with the steps of the introductory part of claim 15 are known. To prepare the stream of material, it is necessary ideally to produce a so-called uniform monolayer of the tobacco from the thick-layer and usually unevenly distributed tobacco, in order to simplify or allow at all the detection of foreign bodies in the stream of material and separation thereof from the stream of material. Such apparatuses have, apart from the delivery device and the apparatus for removing foreign matter from the stream of material, the so-called string remover, a vibrating element, e.g. a vibrating belt or a vibrating channel, which is intended to be used to even out the stream of material. Downstream from the vibrating element in the direction of transport is a two-stage conveying element for accelerating the stream of material. At the end of the conveying element is arranged the optical testing element which is designed to separate out the previously detected foreign matter and has suitable devices for this purpose.

Such apparatuses and methods, however, have the drawback that they have a very large design due to the large number of components. Secondly, manufacture of the known apparatuses, in particular because of the large number of components as well as the methods, are very expensive.

### SUMMARY OF THE INVENTION

It is therefore the object of the present invention to propose a cost-efficient and compact apparatus which ensures distribution of the stream of material into a monolayer at least equivalent to conventional apparatuses. Furthermore it is the object of the invention to propose a cost-efficient method which is easy to handle and with low space requirements allows distribution of the stream of material into a monolayer of the required quality.

This object is achieved firstly by an apparatus of the kind mentioned hereinbefore by the fact that the apparatus for removing foreign matter is arranged directly above the conveying element which accelerates the stream of material. As a result, the number of components is reduced, because e.g. the conveying element which is usually located below the apparatus for removing the foreign matter and the vibrating element arranged downstream from the apparatus can be dispensed with, so that a particularly compact and inexpensive-to-make apparatus is provided. Due to the arrangement of the apparatus for removing the foreign matter according to the invention above the conveying element which accelerates the stream of material, direct delivery of the stream of material is ensured, so that the stream of material has fewer transitions to overcome, with the result that the tobacco is conveyed particularly carefully. Furthermore, with the claimed apparatus good pre-distribution of the stream of material is achieved at the same time.

Advantageously, the apparatus for removing foreign matter is composed of several remover rollers arranged adjacent to each other and rotatable by means of a rotary drive, wherein the speed of rotation or conveying of the remover rollers differs from, namely is preferably lower than, the speed of conveying of the conveying element which accelerates the stream of material. Particularly effective evening out is achieved by this speed difference, so that the previously thick-layer and irregular stream of material can be converted to a uniform monolayer of tobacco.

In a preferred embodiment of the invention are provided at least two conveying elements which accelerate the stream of material and which are arranged one behind the other and in cascade fashion, wherein in the region of the rear conveying element is arranged a detection element for foreign bodies, particularly made of metal. As a result, additional and optionally usable components are integrated without increasing the space requirements of the apparatus as a whole.

Furthermore, an embodiment is particularly preferred in which a sifter and the optical testing element form a unit, such that the sifter is directly associated with the optical testing element, namely, arranged immediately downstream from it. This also leads to a compact arrangement of the apparatus.

Secondly, the object is achieved by a method with the steps mentioned hereinbefore by the fact that the stream of material is passed on directly from the apparatus for removing foreign matter from the stream of material to the conveying element which accelerates the stream of material, wherein the stream of material is placed on the conveying element from above. This allows cost-efficient removal of foreign matter, because reliable evening out of the stream of material is achieved with low space requirements, which is a precondition for the detection and removal of foreign matter and/or foreign bodies.

Preferably, the conveying element is driven at a higher speed of conveying than the remover rollers, preferably at a speed 2 to 3 times higher. As a result, an optimised monolayer evenly distributed in length and breadth is created.

### BRIEF DESCRIPTION OF THE DRAWINGS

Further preferred and advantageous characteristics and developments are apparent from the subsidiary claims and the description. A particularly preferred embodiment and the method are described in more detail with the aid of the attached drawings. The drawings show:

FIG. 1 a schematic side view of an apparatus for removing foreign matter from tobacco to be processed,

FIG. 2 a schematic plan view of the apparatus as in FIG. 1 with a detection element, and

FIGS. 3a to d schematic views of remover rollers as part of the apparatus for removing foreign matter from the stream of material.

### DETAILED DESCRIPTION OF THE INVENTION

The apparatuses shown serve to remove foreign matter, e.g. threads of the packing material, metal parts and the like, from a usually continuously conveyed stream of material.

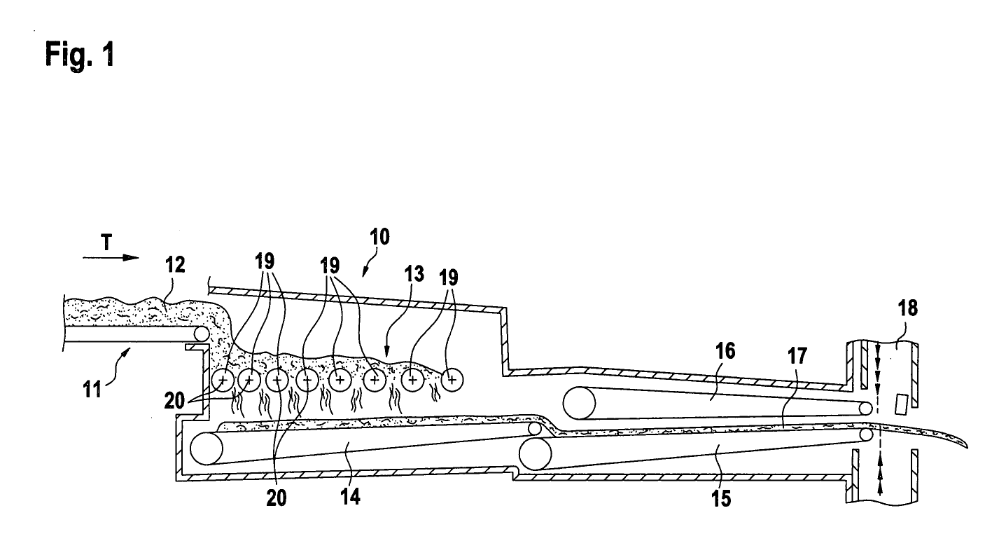

The apparatus 10 according to FIG. 1 includes a delivery device 11 which can be designed as a channel, conveyor belt, chute or the like. On the delivery device 11 is arranged the stream of material 12 to be treated, which is laid, poured or otherwise placed on the delivery device 11 and conveyed continuously or intermittently in the direction of transport T. The stream of material 12 in the region of the delivery device 11 is as a rule distributed in a thick layer and irregularly in the direction of transport T and transversely thereto. Behind the delivery device 11 in the direction of transport T is arranged an apparatus 13 for removing foreign matter from the stream of material 12, wherein the apparatus 13 is located slightly below the delivery device 11 in the vertical direction, so that the stream of material 12 has a gradient to overcome. Directly and immediately below the apparatus 13 is arranged a first conveying element 14 which serves to accelerate the stream of material 12 falling from above. Between the apparatus 13 and the conveying element 14 a gap is provided in the vertical direction. A further conveying element 15 is assigned to the conveying element 14, wherein the conveying elements 14, 15 are arranged one behind the other and in cascade fashion. This means that the conveying element 15 in the vertical direction is arranged slightly below and overlapping the conveying element 14, so that the stream of material 12 has a gradient to overcome. Above the conveying element 15 is arranged a further conveying element 16 which extends almost over the whole length of the conveying element 15 in the direction of transport T and runs approximately parallel or in a wedge shape to the latter in the direction of transport T. The stream of material 12 is processed within the apparatus 10 into a monolayer 17 which, lying on the conveying element 15, can be transported into the region of an optical testing element 18. The optical testing element 18 has a device for separating the previously detected foreign matter from the tobacco or from the monolayer 17. For this purpose the optical testing element 18 is connected by its above-mentioned device to a control and/or regulating unit (not shown).

The apparatus 13 for removing the foreign matter from the stream of material 12 has several remover rollers 19 arranged adjacent to each other or one behind the other in the direction of transport T. The remover rollers 19 are rotatable by means of rotary drives (not shown) about their respective axis of rotation 20, wherein the axes of rotation 20 of the remover rollers 19 run parallel to each other and transversely to the direction of transport T. All the remover rollers 19 are provided with a gap from the respectively adjacent remover roller 19. The gaps between the individual remover rollers 19 can be the same. However, a variable gap is preferred, this being in particular such that the gaps between the remover rollers 19 increase in the direction of transport T.

The speeds of rotation or conveying of all the remover rollers 19 of an apparatus 13 are the same and synchronised. By suitable control and drive means, however, a separate speed of conveying can be produced for each remover roller 19 or groups of remover rollers. The speed of conveying of the remover rollers 19 on the one hand and of the conveying elements 14, 15 on the other hand differ from each other. Preferably, the speed of conveying of the remover rollers 19 is lower than the speeds of conveying of the conveying elements 14 and 15. The speed of conveying of the conveying element 14 is approximately 2 to 3 times higher than the speed of conveying of the remover rollers 19. Compared with the conveying element 14, the conveying element 15 has a higher speed which is preferably about twice as high. Other speed ratios can, however, be produced in particular dependent on the desired result in formation of the monolayer 17. The conveying element 16 in the shown embodiment has approximately the same speed of conveying as the conveying element 15 during operation. The conveying element 16 provided in particular for generating an air stream can, however, also have a speed of conveying different to the speed of conveying of the conveying element 15.

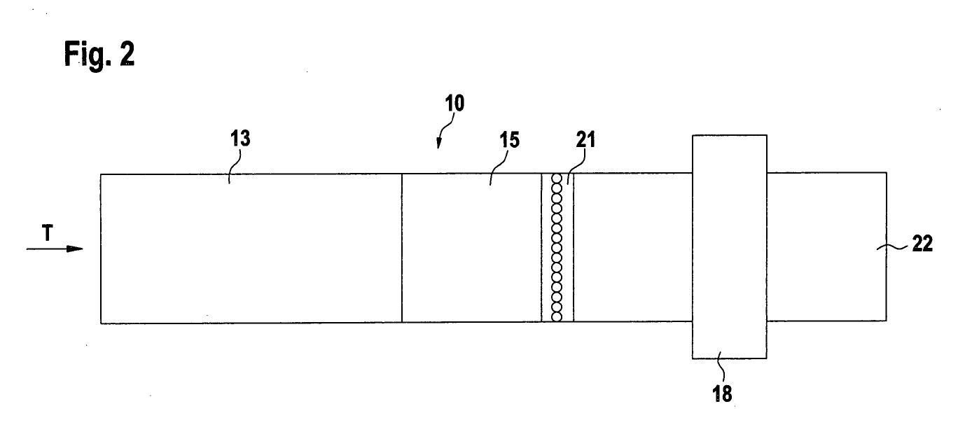

In the region of the rear conveying element 15 can optionally also be arranged a detection element 21 (see in particular FIG. 2). The detection element 21 serves to detect foreign bodies in particular made of metal (e.g. aluminium foil) within the monolayer 17. The detection element 21 is of linear construction and extends across the full width of the conveying element 15, so that the monolayer 17 can be detected synchronously across the full width.

In a further embodiment an additional sifter 22, which can also be designed as a separator (air separator), and the optical testing element 18 form a unit. The sifter 22 is directly and immediately assigned to or arranged behind the testing element 18, and is ideally even an integral part of the testing element 18. The sifter 22 is designed in the usual known manner optionally for sifting light parts or sifting heavy parts, so that a detailed description is dispensed with.

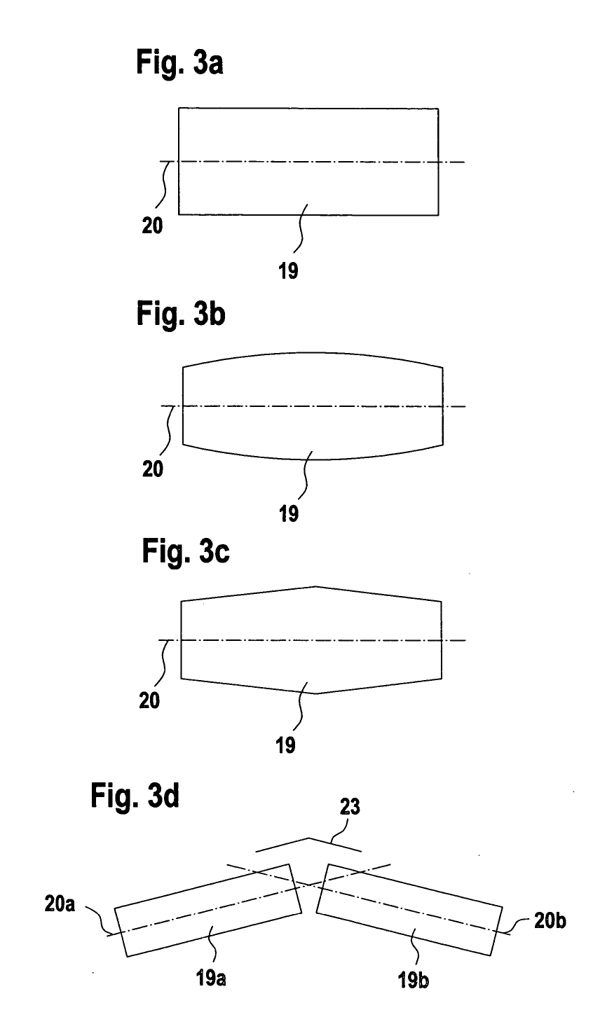

In embodiments not shown explicitly, the gaps between the remover rollers 19 can also decrease in the direction of transport T. Also the shape and design of the remover rollers 19 can vary. In FIGS. 3a to c only selected examples are shown. In FIG. 3a a conventional cylindrical roller shape is shown. The convex roller shape shown in FIG. 3b in which, starting from the edge, the diameter increases towards the centre and then decreases again to the opposite end, serves particularly for improved distribution or evening out of the stream of material 12 transversely to the direction of transport T. The same applies to the roller shape as in FIG. 3c. Also different roller shapes can be combined in one apparatus 13. The remover rollers 19 also do not have to be oriented parallel to each other, but can be arranged at an angle to each other, e.g. in a zigzag shape in plan view. FIG. 3d shows a further embodiment of the design of the remover rollers 19 which serves for uniform tobacco distribution. In this, each remover roller 19 is split, this being into two roller elements 19a and 19b. The roller elements 19a and 19b or their axes of rotation 20a or 20b run obliquely to each other. In the region of a point of intersection of the axes of rotation 20a and 20b can optionally be provided a cover element 23 which closes the gap between the tilted roller elements 19a and 19b.

Below, the principle of the method is described in more detail with the aid of FIGS. 1 and 2. At one or more delivery points, raw tobacco is placed on the delivery device 11 as bulk material or otherwise over the full width or only in defined regions. By means of the delivery device 11 the tobacco is conveyed in the direction of transport T as a stream of material 12 in a thick layer which can have different heights. The stream of material 12 drops onto the remover rollers 19 at the junction with the apparatus 13, i.e. the string remover, as described e.g. in the document of EP application number 03090079.9. By rotation of the remover rollers 19, the stream of material 12 is conveyed in the direction of transport T and pre-distributed in the process. This means that the stream of material 12 is pulled apart, that is, thinned. Due to the variable gaps, or gaps increasing in the direction of transport between the remover rollers 19, the tobacco then falls evenly onto the driven conveying element 14. The stream of material 12 on the conveying element 14 is already much thinner and above all considerably more even compared to the delivery device—inter alia due to the higher speed of conveying of the conveying element 14 compared with that of the remover rollers 19. Foreign matter in the stream of material 12, e.g. threads from the jute sacks as packing material of the raw tobacco, is picked up by the remover rollers 19 and hence removed from the stream of material.

The stream of material 12 lying on the conveying element 14 is accelerated, this being in two stages, as the stream of material 12 is transferred from the conveying element 14 with a first speed of conveying v₁ to the conveying element 15 with a second speed of conveying v₂, where v₂>v₁. In the region of the transition from the conveying element 14 to the conveying element 15, the stream of material 12 drops down onto the conveying element 15, as a result of which the stream of material 12 is pulled still further apart to form the monolayer 17. This monolayer 17 is held on the conveying element 15 in the embodiment shown by an air stream which is generated by the drive of the conveying element 16. By the conveying element 15, the monolayer 17 is passed through the optical testing element 18 in which foreign matter and/or foreign bodies are detected and directly and selectively separated out in a known manner.

Optionally, the monolayer 17 can also be detected before entering the optical testing element 18, wherein in particular metal parts are detected and separated out of the monolayer 17. The detected and/or optically tested monolayer 17 which is freed from foreign matter and/or foreign bodies is then delivered for further processing. The monolayer 17 can be delivered via a transport element to a sifter 22. For this purpose the monolayer 17 or the tobacco falls in a parabolic curve onto the transport element. Preferred is, however, delivery of the monolayer directly to the sifter 22, wherein the tobacco falls in a parabolic curve directly into the sifter 22. Depending on the customer's requirement, sifting of heavy parts or sifting of light parts can take place in the sifter 22.

If using the remover rollers 19 in FIGS. 3b and c, the stream of material 12 is expanded in the region of the apparatus 13, namely due to the special shape passed in particular to the outer edges of the remover rollers 19, so that evening out occurs by pulling the stream of material apart transversely to the direction of transport T.

The invention has been described in detail with respect to exemplary embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. Apparatus for removing foreign matter from tobacco to be processed, in the direction of transport T of the tobacco, including a delivery device for delivering a stream of material substantially consisting of tobacco, an apparatus for removing foreign matter from the stream of material, at least one conveying element which accelerates the stream of material, and an optical testing element for detecting further foreign matter with a device for separating the foreign matter from the tobacco, characterized in that the apparatus for removing foreign matter is arranged directly above the conveying element which accelerates the stream of material.

2. Apparatus according to claim 1, characterized in that the apparatus for removing foreign matter is composed of several remover rollers arranged adjacent to each other and rotatable by means of a rotary drive, wherein the speed of rotation or conveying of the remover rollers differs from the speed of conveying of the conveying element which accelerates the stream of material.

3. Apparatus according to claim 2, characterized in that the speed of conveying of the conveying element is higher than the speed of conveying of the remover rollers.

4. Apparatus according to claim 1, characterized in that at least two conveying elements which accelerate the stream of material are provided, which are arranged one behind the other and in cascade fashion.

5. Apparatus according to claim 4, characterized in that the speed of conveying of the rear conveying element in the direction of transport T is higher than the speed of conveying of the front conveying element.

6. Apparatus according to claim 4, characterized in that above the rear conveying element is arranged a further conveying element, wherein the conveying elements are spaced apart from each other.

7. Apparatus according to claim 4, characterized in that in the region of the rear conveying element is arranged a detection element for foreign bodies, particularly made of metal.

8. Apparatus according to claim 7, characterized in that the detection element is of linear construction and extends across the full width of the conveying element.

9. Apparatus according to claim 2, characterized in that the remover rollers are optionally of cylindrical construction and/or have a shape differing from the cylindrical construction.

10. Apparatus according to claim 2, characterized in that each of the remover rollers arranged adjacent to each other is arranged at a distance from the or each adjacent remover roller.

11. Apparatus according to claim 10, characterized in that the distance between the remover rollers increases in the direction of transport T of the stream of material.

12. Apparatus according to claim 1, characterized in that the delivery device is variably shaped, such that different delivery regions of the stream of material onto or into the apparatus for removing foreign matter can be selected.

13. Apparatus according to claim 1, characterized in that a sifter and the optical testing element form a unit, such that the sifter is directly associated with the optical testing element, namely, arranged immediately behind it.

14. Apparatus according to claim 13, characterized in that the sifter is an integral part of the optical testing element.

15. Method for removing foreign matter from tobacco to be processed, including the steps of:
delivering a stream of material substantially consisting of tobacco to an apparatus for removing foreign matter from tobacco to be processed,
removing foreign matter from the stream of material by means of the corresponding apparatus,
passing the stream of material onto a conveying element which accelerates the stream of material,
detecting further foreign matter by means of an optical testing element, and
separating the foreign matter from the tobacco,
characterized in that the stream of material is passed on directly from the apparatus for removing foreign matter from the stream of material to the conveying element which accelerates the stream of material, wherein the stream of material is placed onto the conveying element from above.

16. Method according to claim 15, characterized in that remover rollers of the apparatus for removing the foreign matter on the one hand and the conveying element on the other hand are driven at different speeds of conveying.

17. Method according to claim 16, characterized in that the conveying element is driven at a higher speed of conveying than the remover rollers, preferably at a speed 2 to 3 times higher.

18. Method according to claim 15, characterized in that the stream of material is guided from the conveying element, which accelerates the stream of material, onto a lower conveying element arranged behind it, which also accelerates the stream of material.

19. Method according to claim 18, characterized in that the rear conveying element in the direction of transport T is driven at a higher speed of conveying than the front conveying element.

20. Method according to claim 18, characterized in that the stream of material is held on the conveying element by an air stream which is generated by a further conveying element arranged above the rear conveying element.

21. Method according to claim 18, characterized in that the stream of material lying on the rear conveying element is detected.

22. Method according to claim 21, characterized in that the stream of material is detected at the same time across the whole width of the conveying element.

23. Method according to claim 16, characterized in that the stream of material optionally widens or narrows transversely to the direction of transport during transport over the remover rollers.

24. Method according to claim 15, characterized in that the stream of material is delivered directly to a sifter immediately after emergence from the optical testing element.
